(19) United States
(12) Patent Application Publication
(10) Pub. No.: US 2007/0079477 A1
(43) Pub. Date: Apr. 12, 2007

(54) Shaft structure

(76) Inventor: Kuo-Hua Huang, Taipei County (TW)

Correspondence Address: Kuo-Hua Huang, 235 Chung - Ho, Box 8-24, Taipei, TW

(21) Appl. No.: 11/448,655

(22) Filed: Jun. 8, 2006

(30) Foreign Application Priority Data
Oct. 6, 2005 (TW) 094209701

(51) Int. Cl. E05D 11/08

(52) U.S. Cl. 16/342

(57) ABSTRACT

A shaft structure located aside the coupled portion of two objects comprises a pivot shaft, a sleeve barrel and a connecting part. The pivot shaft further includes a retaining terminal and a rotary section. The inner surface of the sleeve barrel is provided with a slot for retaining the rotary section when it is inserted therein, whereby the two objects connected by the retaining terminal and the connecting part may have a relative pivotal motion. Further, the retaining terminal of the shaft and the connecting part may have various shapes according to the objects they are connected with. The tightness between the sleeve barrel and the rotary section can be adjusted to achieve a variety of damping. Therefore, the shaft structure is simple and versatile.

### FIELD OF THE INVENTION

The present invention relates shaft structures used in computers and other electronic devices for providing the effects of loosening and rotation so as to attain a preferred pivoting and retaining effect. The present invention has a simple structure comprising only a shaft, a sleeve barrel and a connecting part, which is of low production cost and versatile.

### BACKGROUND OF THE INVENTION

There are a wide range of applications concerning rotary shafts in computer devices (notebook computers, LCD displays and tablet computers) and in other electronic device (cell phones, translators, PDAs and digital video cameras). A rotary shaft provides pivotal coupling between two objects. In one prior art, as shown in FIGS. 1 and 3, the prior art discloses a positioning shaft 10, a rotary shaft 11 and a torsion unit 12 between the positioning shaft 10 and the rotary shaft 11. The torsion unit 12 comprises a plurality of half-open washers 13 and closed washers 14, which provides necessary friction to limit the rotational motion when the system is assembled. However, the invention of the prior art has the disadvantages of complicated structure and therefore high production cost. It is a further disadvantage that the shapes of the positioning shaft 10 and the rotary shaft 11 cannot be changed to accommodate objects of various shapes.

### SUMMARY OF THE INVENTION

The primary objective of the present invention is to provide a shaft structure comprising a pivot shaft, a sleeve barrel and a connecting part. A shaft structure located aside the coupled portion of two objects. The pivot shaft further includes a retaining terminal and a rotary section respectively connected to two objects. The rotary section of the pivot shaft is inserted into the sleeve barrel tightly. Therefore, the shaft structure is simple and versatile, significantly reducing the production cost.

The secondary objective of the present invention is to provide a shaft structure wherein the tightness between the sleeve barrel and the rotary section can be adjusted to achieve degrees of damping according the weights of the object the shaft connected.

It is a further objective of the present invention that the shaft structure comprises a pivot shaft, a sleeve barrel and a connecting part. The retaining terminal and the connecting part are respectively mounted on two objects. In other words, the retaining terminal and the connecting part are merely for connection, much simpler compared to the conventional mechanisms.

The various objects and advantages of the present invention will be more readily understood from the following detailed description when read in conjunction with the appended drawings.

### BRIEF DESCRIPTION OF THE DRAWINGS

FIG. 1 is an exploded perspective view of the prior art.

FIG. 2 is a perspective view of the prior art.

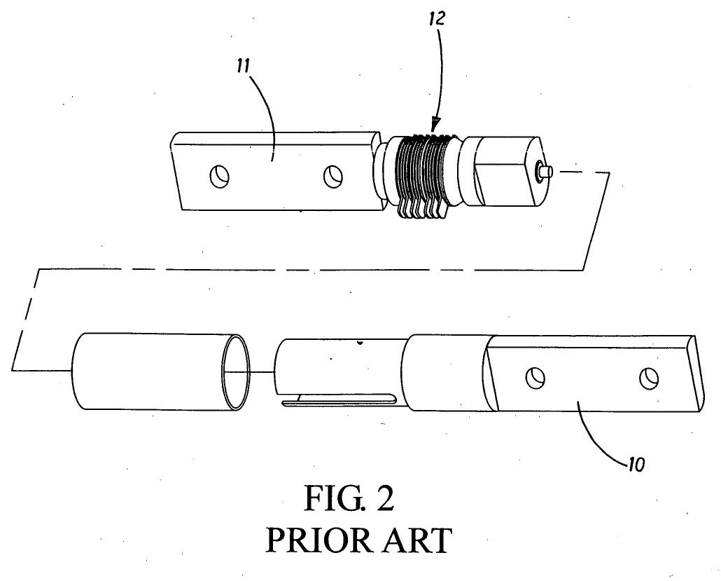

FIG. 3 is a perspective view of a preferred embodiment of the present invention.

FIG. 3A illustrates the use of the first preferred embodiment of the present invention.

FIG. 3B illustrates the combination of the sleeve barrel on to a section of ridged surface of the connecting part.

FIG. 3C illustrates a preferred embodiment of the present invention wherein the connecting part is a T-shaped work piece.

FIG. 3D illustrates the combination of the sleeve barrel on a base and a connecting piece.

FIG. 3E illustrates the use of the preferred embodiment in FIG. 3D.

FIG. 3F is another view showing the combination of the sleeve barrel on a base and a connecting piece.

FIG. 3G illustrates the use of the preferred embodiment in FIG. 3F.

FIG. 4 illustrates the combination of the retaining terminal of the pivot shaft and a sleeve mount, accompanied by L-shaped or T-shaped work pieces.

FIG. 4A illustrates the use of the preferred embodiment in FIG. 4.

FIG. 5 illustrates the combination between the retaining terminal of the pivot shaft and a cantilever arm.

FIG. 5A illustrates the use of the preferred embodiment in FIG. 5.

FIG. 6 illustrates the combination between the sleeve mount, the sleeve barrel and the pivot shaft.

FIG. 6-1 illustrates the use of the preferred embodiment in FIG. 6.

FIG. 6A shows the connecting part is a tubular body.

FIG. 6B illustrates the use of the preferred embodiment in FIG. 6A.

FIG. 6C shows the connecting part is a T-shaped tubular body.

FIG. 6D illustrates the use of the preferred embodiment in FIG. 6C.

FIG. 7 shows another preferred embodiment wherein the connecting part is a straight tubular body.

FIG. 8 shows another preferred embodiment wherein the connecting part is a T-shaped body.

### DETAILED DESCRIPTION OF THE PREFERRED EMBODIMENTS

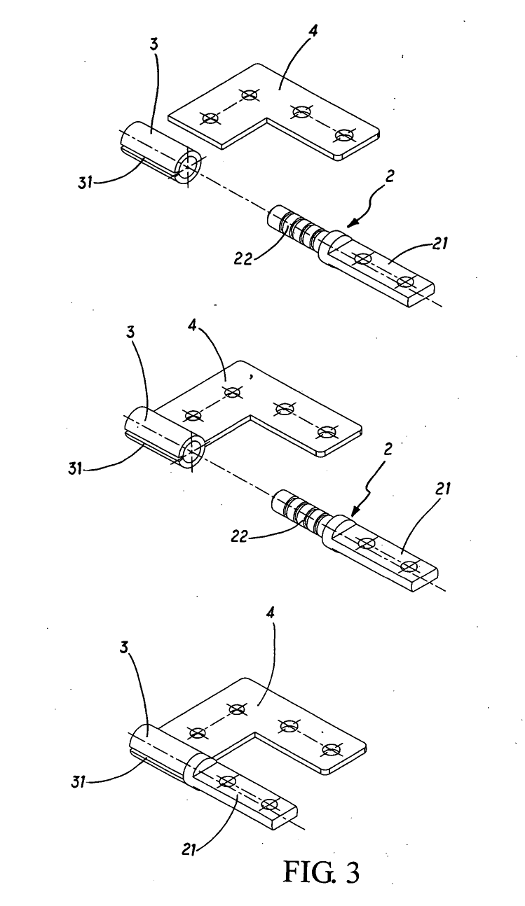

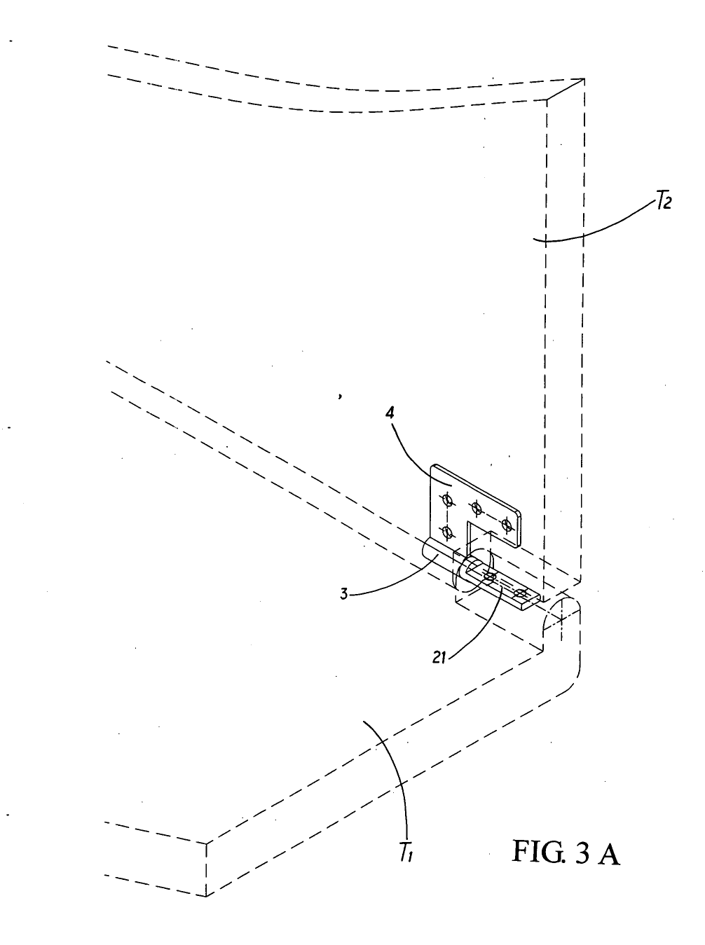

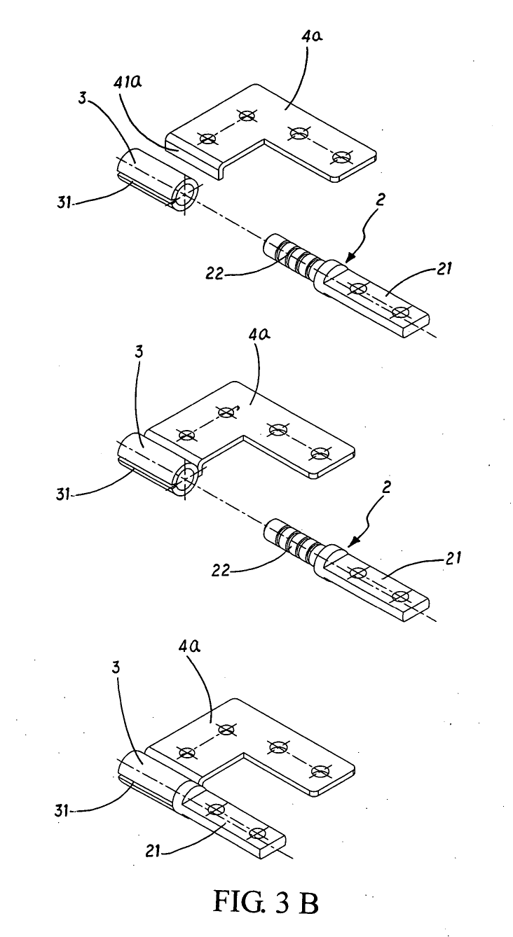

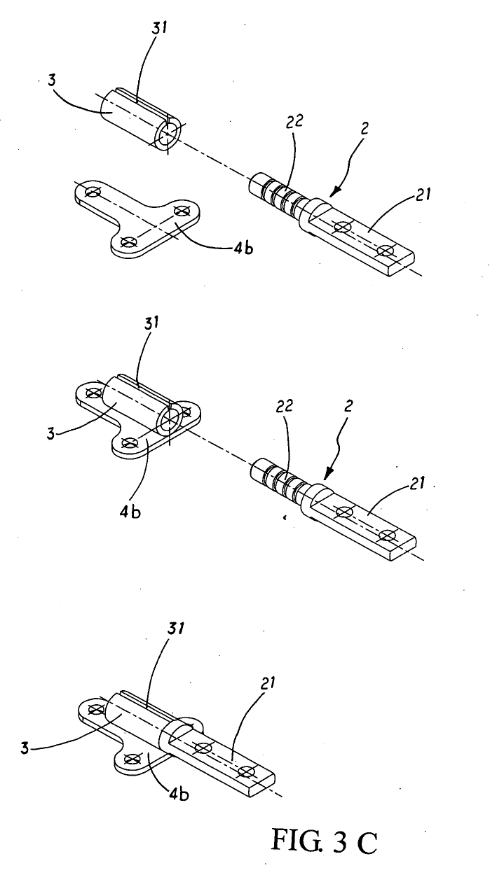

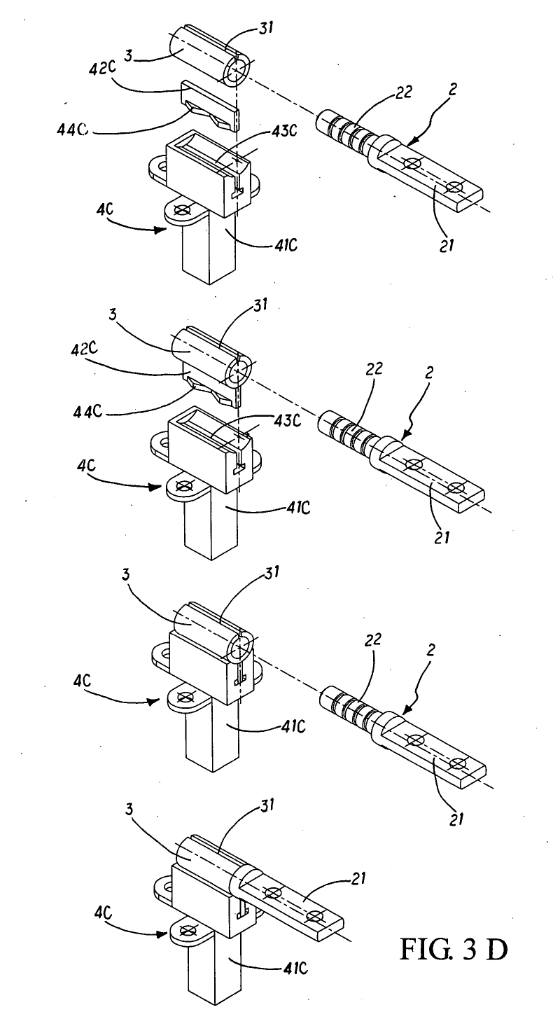

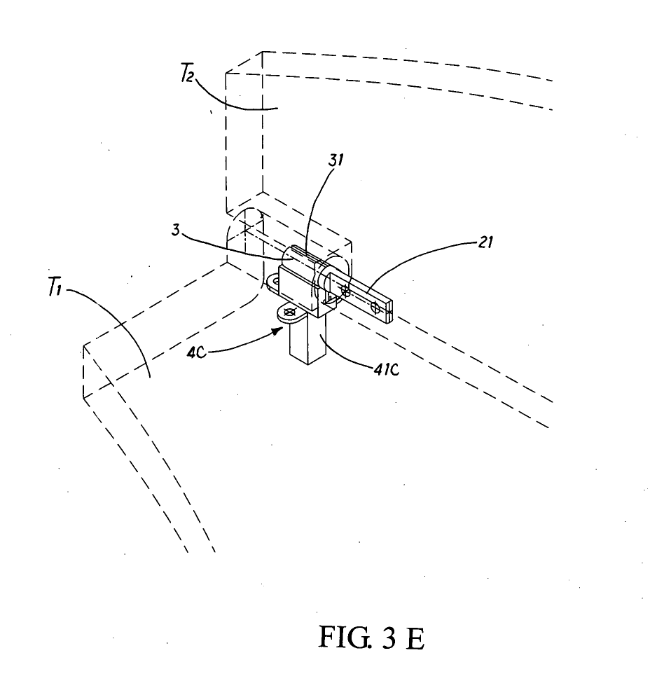

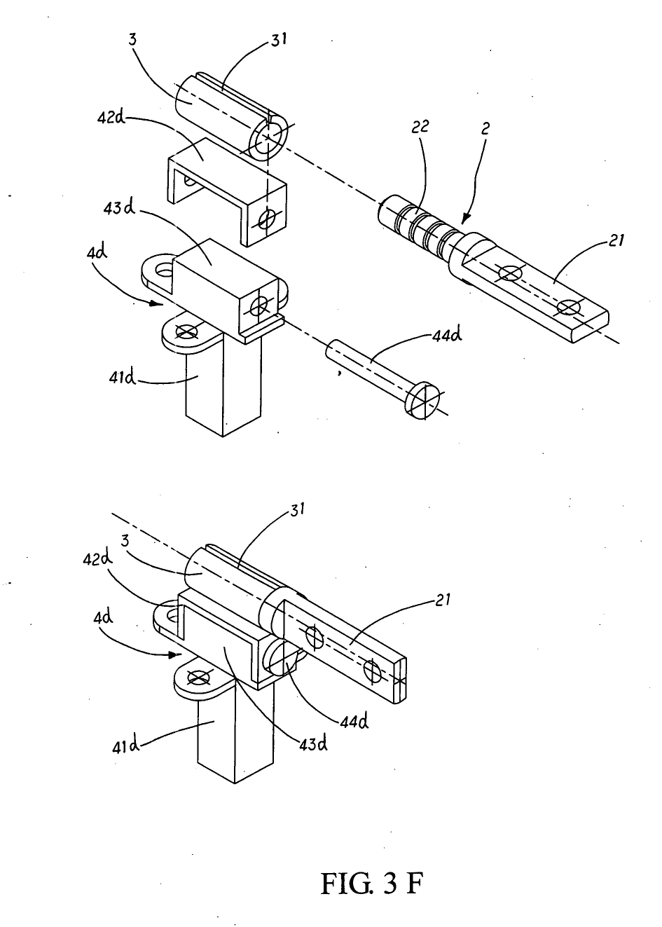

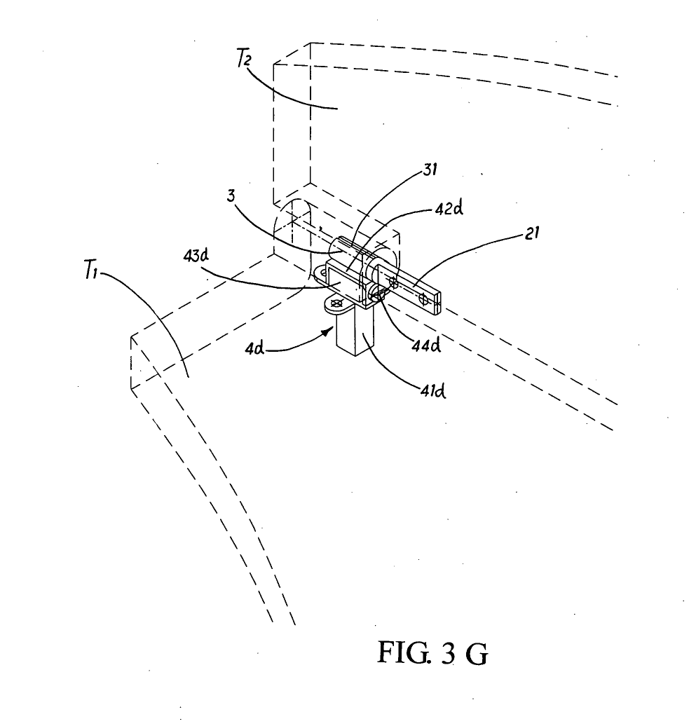

Referring to FIGS. 3 and 3A, a shaft structure 1 disposed adjacent to the coupled portion of two objects T1 and T2 comprises a pivot shaft 2, a sleeve barrel 3 and a connecting part 4. The pivot shaft 2 further comprises a retaining terminal 21 and a rotary section 22. The retaining terminal 21 is mounted on the object T1. The rotary section 22 is inserted into the sleeve barrel 3; the inner surface of the sleeve barrel 3 further includes an axial slot 31 for retaining the rotary section 22. The connecting part 4 is mounted on the other object T2, and one end of the connecting part 4 is in turn connected around the sleeve barrel 3, being corresponding to a predetermined location opposite to the slot 31. Thereby, the retaining terminal 21 and the connecting part 4 are mounted on the objects Ti and T2, and the rotary section 22 is coupled tightly within the sleeve barrel 3, providing the objects T1 and T2 with relative rotational motion. Further, the tightness between the sleeve barrel 3 and the rotary section 22 can be adjusted to achieve a damping effect of variable degree.

Further, to accommodate objects of various shapes, the retaining terminal 21 and the connecting part 4 can be various shapes.

Referring to FIGS. 3B and 3C, the connecting parts 4a and 4b are respectively L-shaped and T-shaped. The L-shaped connecting part 4a has a section provided with ridged surface 41a for the attachment of the sleeve barrel 3, whereby the connection of the connecting part 4a and the sleeve barrel 3 are facilitated. The T-shaped connecting part 4b is mounted on an object, so that the connection can be stable.

Referring to FIGS. 3D and 3E, the connecting part 4c further comprises a base 41c, connected with the object T1, having a groove 43c thereon for facilitating connecting piece 42c. Thereby, the connecting piece 42c will be coupled with the sleeve barrel 3. The bottom surface of the connecting piece 42c has a projected portion 44c for coupling the groove 43c, whereby the sleeve barrel 3 and the connecting part 4c can be integrated tightly. The connecting part 4c and the retaining terminal 21 of the pivot shaft 2 are respectively connected to the objects T1 and T2, whereby the objects T1 and T2 may have a relative rotational motion.

Referring to FIGS. 3F and 3G, the connecting part 4d is similar to that in FIG. 3D, which comprises a base 41d and a connecting piece 42d. The base 41d is mounted on an object T1 and has a bumped top surface 43d, whereas the connecting piece 42d takes a concave U shape. The top surface of the connecting piece 42d us coupled with the sleeve barrel 3, and the bottom surface can be engaged with the bumped surface 43d. Further, the connecting piece 42d and the bumped surface 43d are respectively provided with through holes for receiving an insertion pin 44d when aligned, whereby the connecting piece 42d and the bumped surface 43d will be fixed. The connecting part 4d and the retaining terminal 21 of the pivot shaft 2 are respectively connected to the objects T1 and T2, whereby the objects T1 and T2 may have a relative rotational motion.

Further, the retaining terminal 21 of the present invention is not necessarily mounted on an object, and the connection can be achieved by the following preferred embodiments.

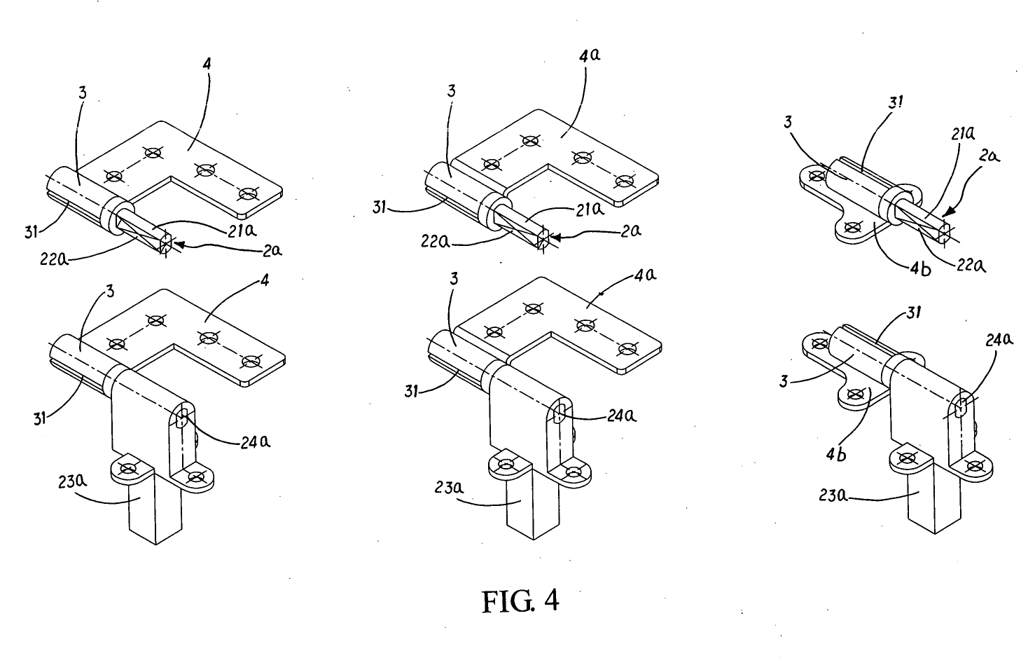

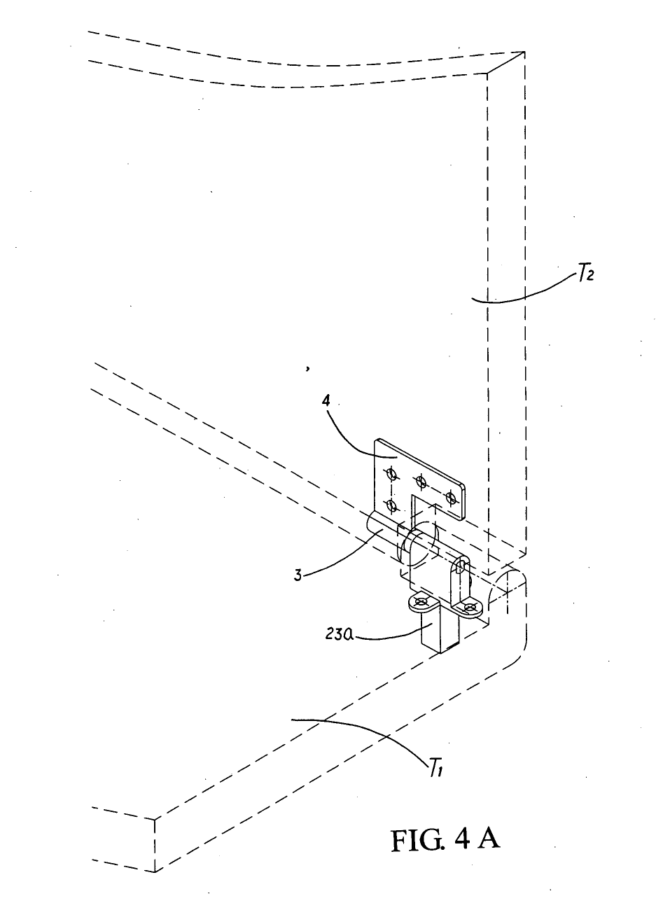

Referring to FIGS. 4 and 4A, the connecting parts 4, 4a and 4b can be L-shaped or T-shaped work pieces. The retaining terminal 21a of the pivot shaft 2a has at least a flat surface 22a, and the top of a shaft mount 23a corresponding to the retaining terminal 21a has a through hole 24a, whereby the retaining terminal 21a will be inserted into the through hole 24a tightly and the shaft mount 23a and connecting parts 4, 4a and 4b are respectively connected with the objects T1 and T2. This configuration will make the object T1 ad the shaft mount 23a stronger.

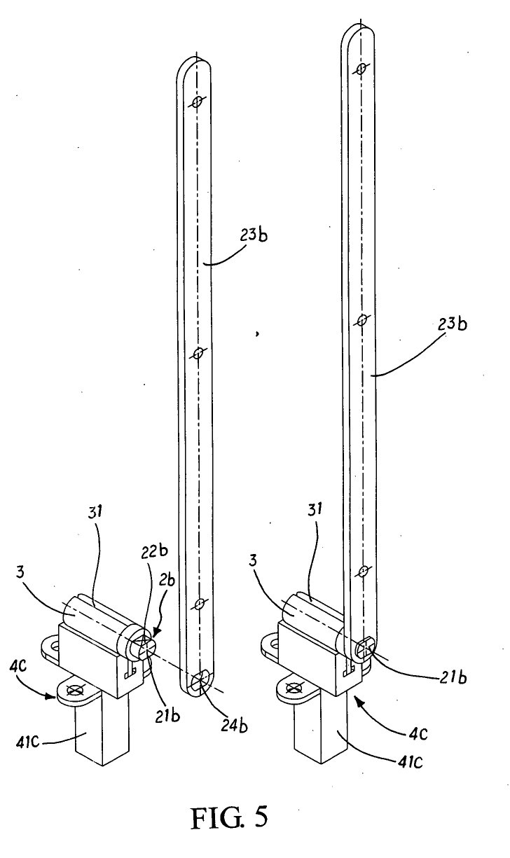

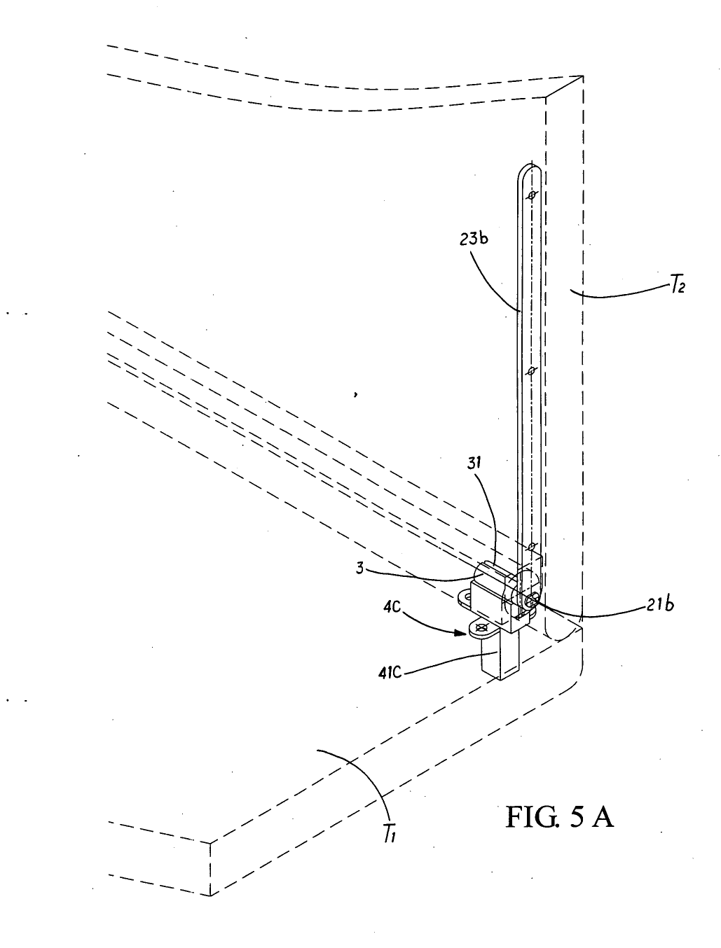

Referring to FIGS. 5 and 5A, the retaining terminal 21b of the pivot shaft 2b has at least a flat surface 22b, and the end of a cantilever arm 23b corresponding to the retaining terminal 21b has a through hole 24b, whereby the retaining terminal 21b and the through hole 24b are rigidly connected and the cantilever arm 23b will be connected with the object T2. This configuration will support the object T2 better and favor the startup of a pivotal motion.

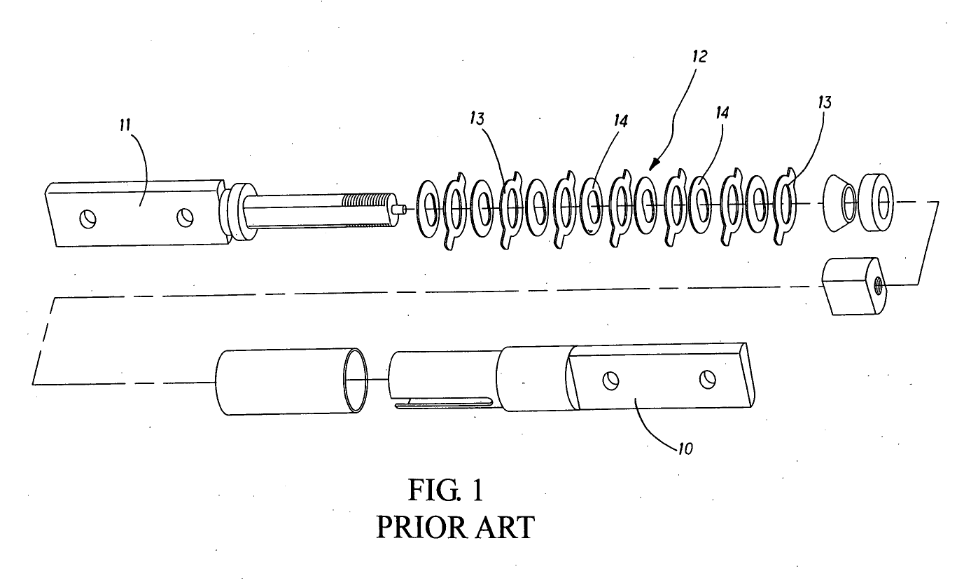

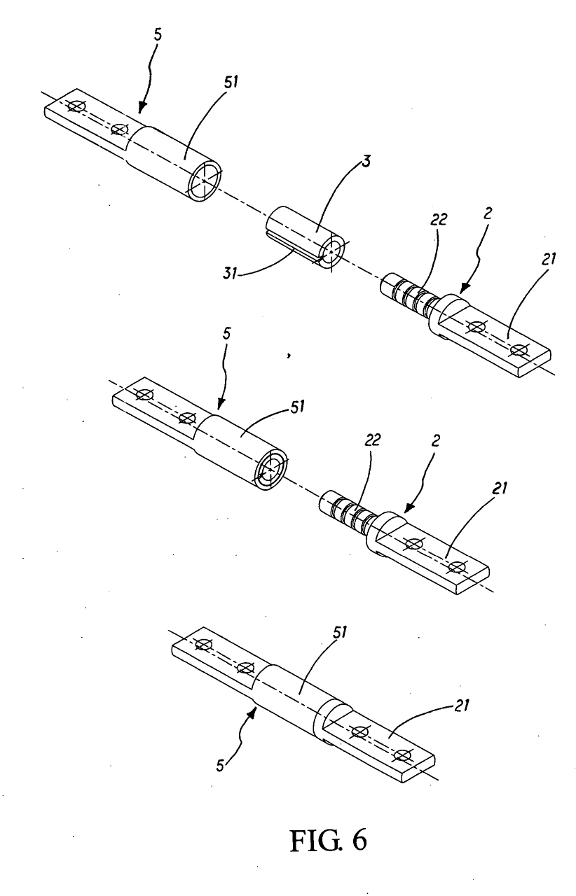

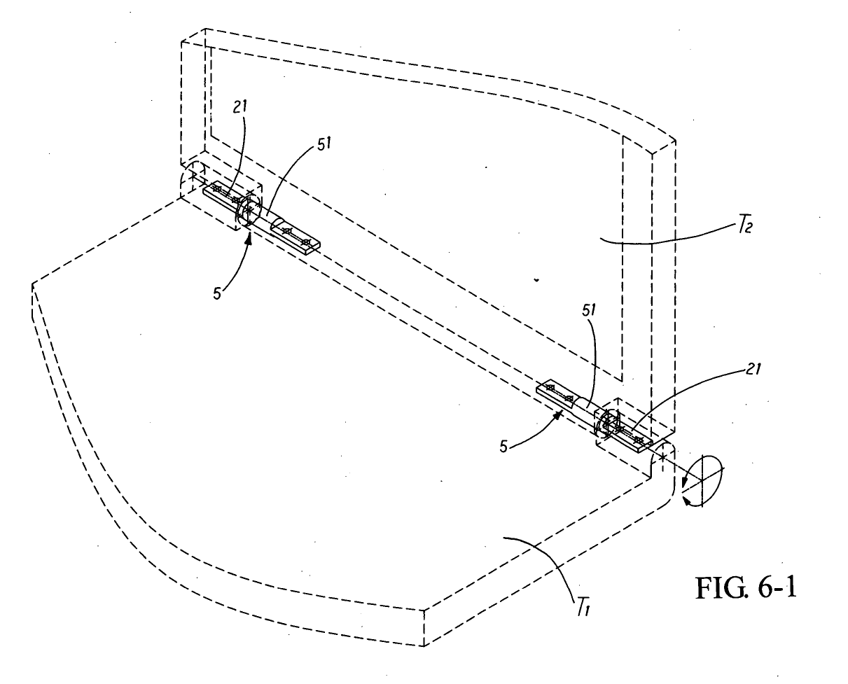

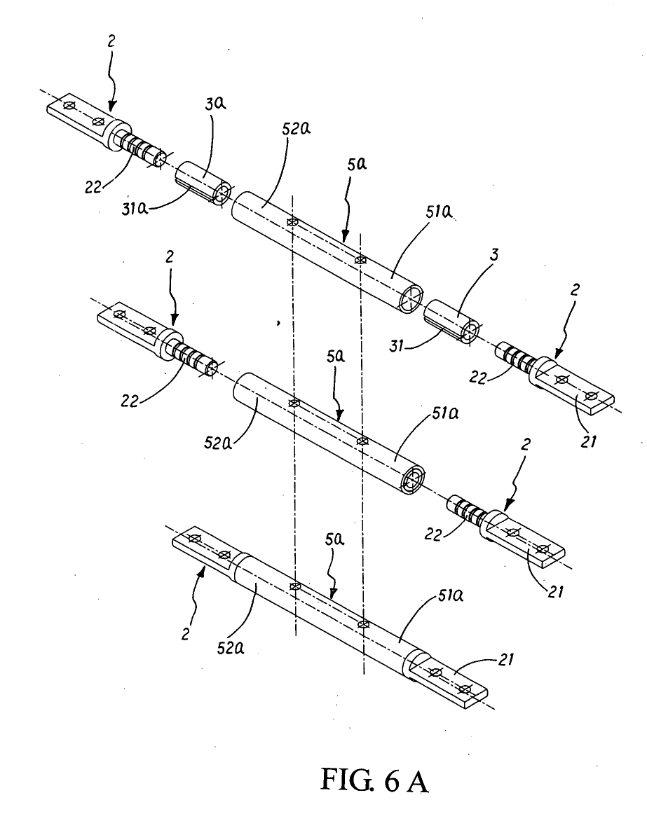

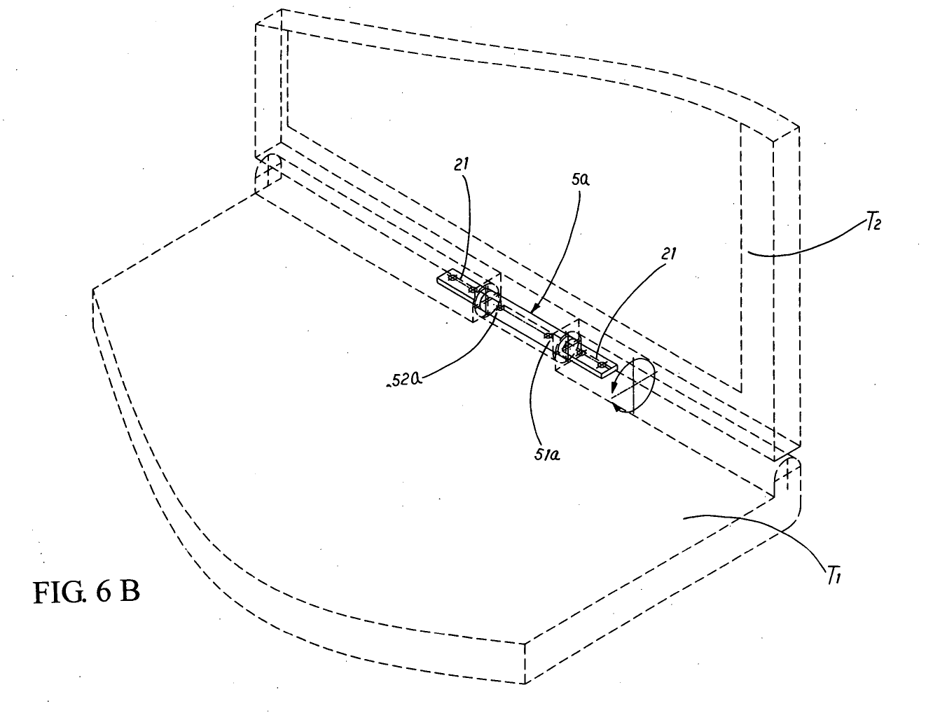

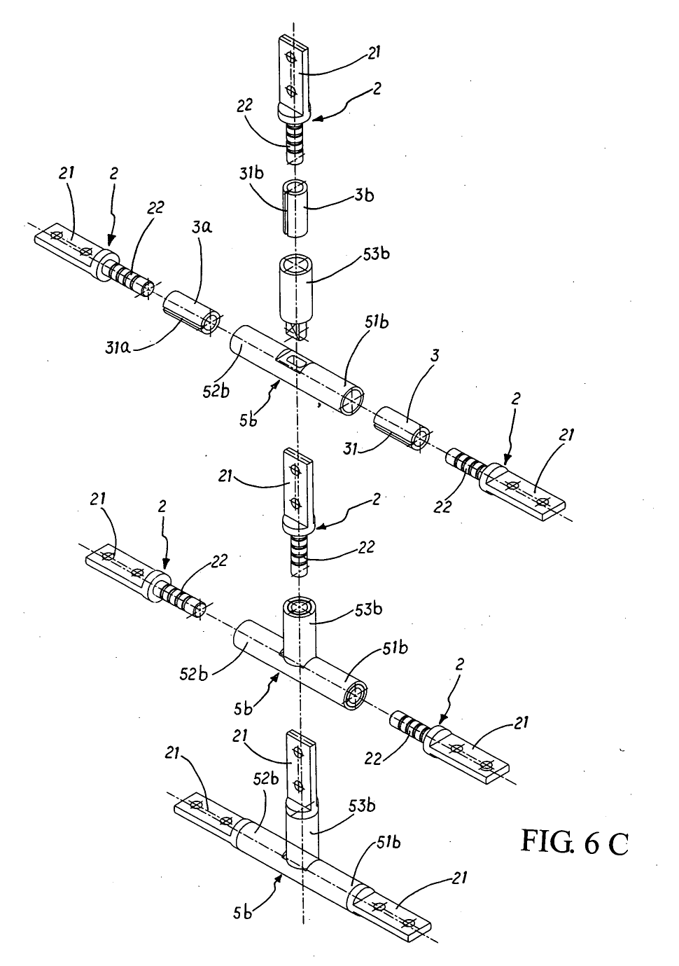

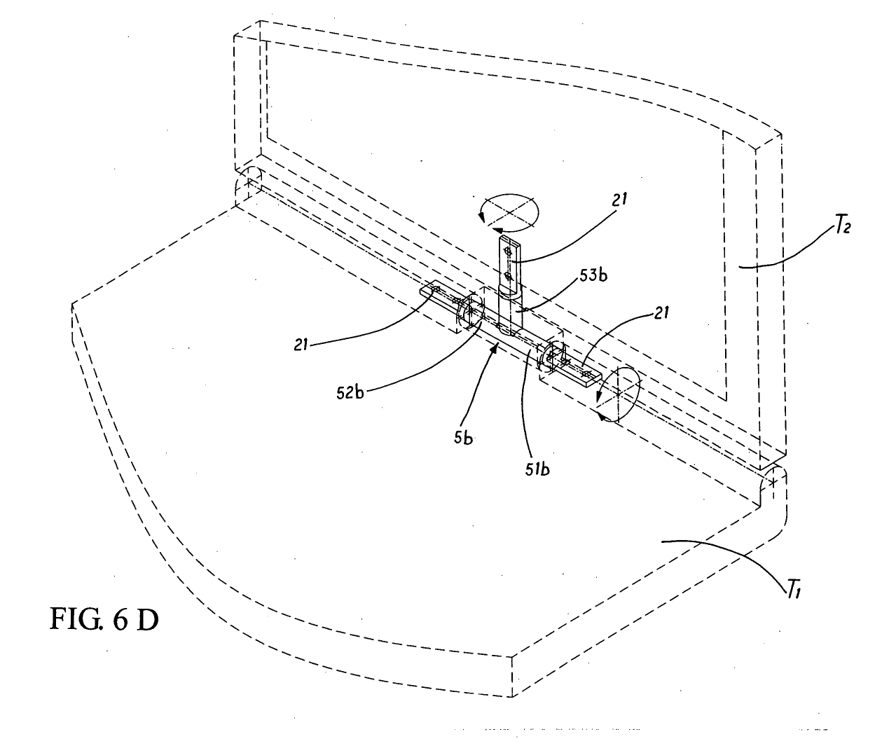

Further, please refer to FIGS. 6 and 6-1 for another preferred embodiment.

The connecting part 5 further comprises a sleeve mount 51, and the sleeve barrel 3 is mounted within the sleeve mount 51. The rotary section 22 of pivot shaft 2 is inserted tightly into the sleeve barrel 3, whereas the connecting part 5 is mounted on the object. Thereby, the sleeve barrel 3 will be connected with the sleeve mount 51 of connecting part 5, which in turn respectively connected with objects T1 and T2. This will largely shrink the space for housing the mechanism and will make the installation easily.

Referring to FIGS. 6A and 6B, the connecting part 5a is substantially a tubular body with two sleeve mounts 51a and 52a. The sleeve mount 51a is inserted with a sleeve barrel 3 and the rotary section 22 of the pivot shaft 2. The other sleeve mount 52a is mounted with another sleeve barrel 3a. The sleeve barrel 3a is further provided with a slot 31a for retaining the rotary section 22 of the pivot shaft 2, together within the sleeve mount 52a. The connecting part 5a is mounted on the object T1, whereby the two objects T1 and T2 may rotate with respect to each other. This configuration is appropriate to be used with cell phones and PADs.

Further, referring to FIGS. 6C and 6D, the connecting part 5b is mounted on an object and has a T-shaped tube. The connecting part 5b further includes sleeve barrels 3, 3a and 3b and sleeve mounts 51b, 52b and 53d. The sleeve barrels 3, 3a and 3b are respectively provided with slots 31, 31a and 31b for holding the sleeve barrels 3, 3a and 3b within the sleeve mounts 51b, 52b and 53d. Thereby, the rotary section 22 of the pivot shaft 2 that is inserted in the sleeve barrels 3, 3a and 3b can be tightly installed.

Thereby, the objects T1 and T2 may undergo pivotal rotation in either horizontal or vertical direction, especially applicable to a flat-panel computer.

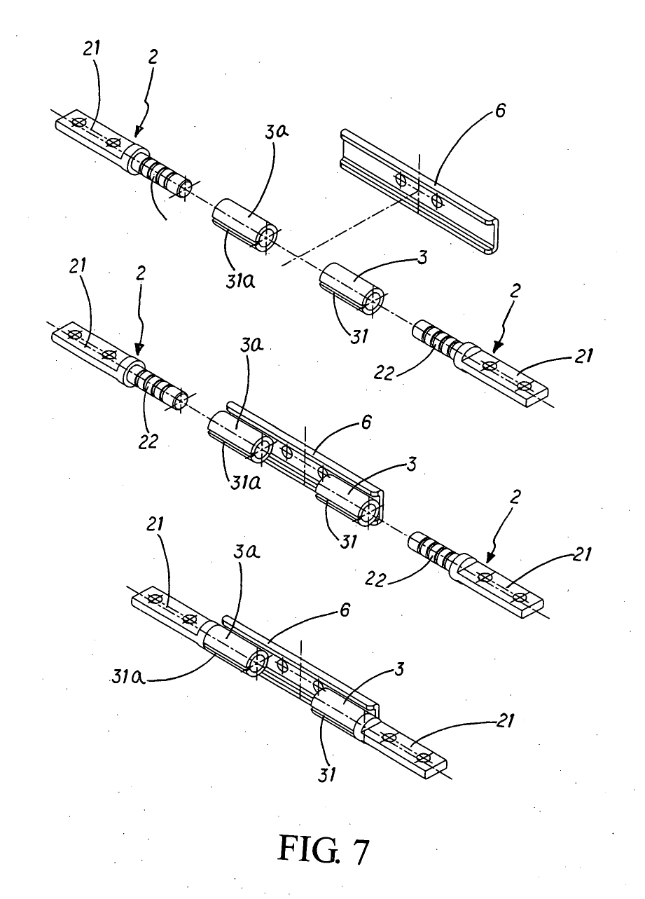

Referring to FIG. 7, the connecting part 6 is a straight tube, with two ends provided with sleeve barrels 3 and 3a. This configuration resembles the same effect of a connecting part of straight-tube type.

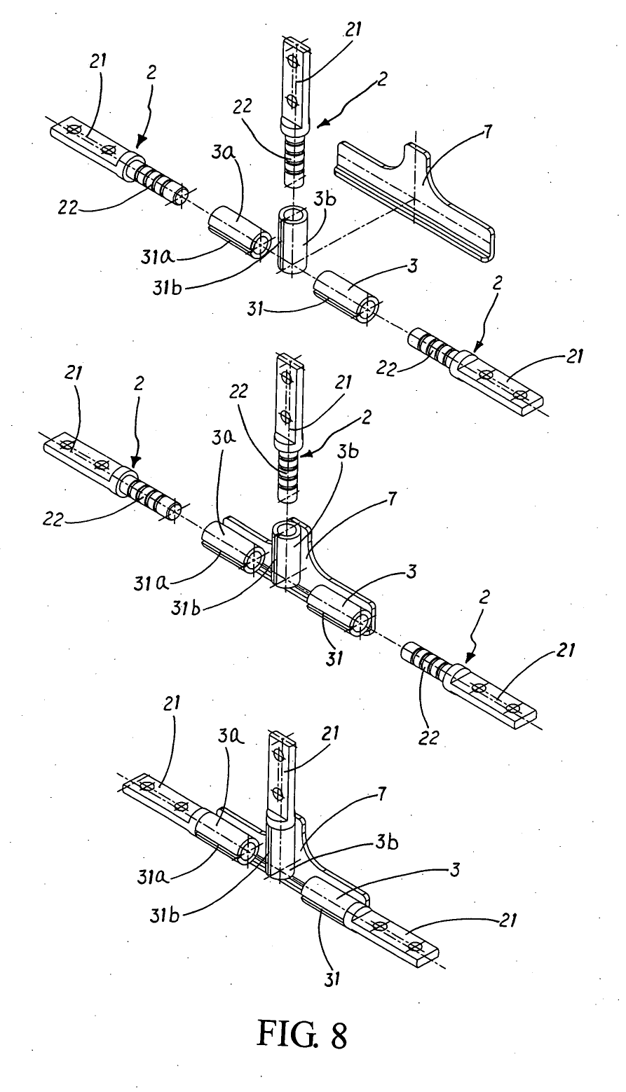

Referring to FIG. 8, another preferred embodiment of the present invention has a T-shaped connecting part 7, which is a T-shaped slab. One end of the connecting part 7 is provided with sleeve barrels 3, 3a and 3b, each being corresponding to the pivot shaft 2. The connecting part 7 is mounted on an object, whereby the rotary section 22 of the pivot shaft 2 is tightly engaged with the sleeve barrels 3, 3a and 3b. Therefore, the configuration achieves same effect of a T-shaped tube.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A shaft structure, comprising:
a pivot shaft having a retaining terminal mounted on an object and a rotary section with an axial slot formed one end thereon;
a sleeve barrel receiving said rotary section of said pivot shaft and being retaining by said pivot shaft; and
a connecting part with one end mounted on a second object and a second end mounted around a lateral surface of said sleeve barrel at a predetermined location.

2. The shaft structure of claim 1 wherein said connecting part is one of an L-shaped piece and a T-shaped piece.

3. The shaft structure of claim 1 wherein said connecting part is an L-shaped work piece; an outer surface of said connecting part being provided with a ridged surface for enhancing the connection between said sleeve barrel and said connecting part.

4. The shaft structure of claim 1 wherein said connecting part further comprises a base with a groove formed on a top surface thereon mounted on an object and a connecting piece whose top surface is connected with said sleeve barrel; said connecting piece having a bottom projected portion capable of being embedded in said groove, reinforcing the connection between said sleeve barrel and said connecting part.

5. The shaft structure of claim 1 wherein said connecting part further comprises a base with a bumped top surface mounted on an object and a connecting piece taking an inverse U shape; said connecting piece covering on said bumped top surface; said connecting piece and said bumped surface being respectively provided with through holes for receiving an insertion pin when aligned, whereby said connecting piece and said bumped surface will be fixed.

6. The shaft structure of claim 1 wherein said retaining terminal of said pivot shaft is connected with a shaft mount; said shaft mount being mounted on an object.

7. The shaft structure of claim 1 wherein said retaining terminal of said pivot shaft has at least a flat surface; a top surface of said shaft mount has a groove corresponding to said retaining terminal of said pivot shaft for receiving said retaining terminal; said shaft mount being mounted on an object.

8. The shaft structure of claim 6 wherein said retaining terminal of said pivot shaft has at least a flat surface; a top surface of said shaft mount has a groove corresponding to said retaining terminal of said pivot shaft for receiving said retaining terminal; said shaft mount being mounted on an object.

9. The shaft structure of claim 1 wherein said retaining terminal of said pivot shaft has at least a flat surface; said retaining terminal and a through hole formed at said retaining terminal are connected; a cantilever arm having one end facing said through hole and another end being mounted on an object.

10. The shaft structure of claim 1 wherein said connecting part further includes a sleeve mount for fixing said sleeve barrel therein; said rotary section of said pivot shaft being tightly inserted into said sleeve barrel; said connecting part being mounted on an object.

11. The shaft structure of claim 1 wherein said connecting part is a tubular body with its two ends having sleeve mounts respectively for fixing said sleeve barrel and said rotary section of said pivot shaft and fixing another a second sleeve barrel and the rotary section of a second pivot shaft; said connecting part being mounted on an object.

12. The shaft structure of claim 1 wherein said connecting part is a T-shaped tubular body with one end connected to an object; said T-shaped tubular body having a sleeve mount for fixing said sleeve barrel; said rotary section of said pivot shaft being tightly inserted into said sleeve barrel.

13. The shaft structure of claim 1 wherein said connecting part is a slab body with one end connected to said sleeve barrel; said connecting part being aligned with said pivot shaft; said rotary section of said pivot shaft being tightly inserted into said sleeve barrel.

14. The shaft structure of claim 1 wherein said connecting part is a T-shaped slab with one end connected to said sleeve barrel; said connecting part being aligned with said pivot shaft; said rotary section of said pivot shaft being tightly inserted into said sleeve barrel.
